(19) United States
(12) Patent Application Publication
(10) Pub. No.: US 2018/0114170 A1
(43) Pub. Date: Apr. 26, 2018

(54) Managing Transportation Capacity

(71) Applicant: PASSUR Aerospace, Inc., Stamford, CT (US)

(72) Inventors: James Barry, Stamford, CT (US); Ron Dunsky, Stamford, CT (US)

(21) Appl. No.: 15/789,487

(22) Filed: Oct. 20, 2017

Related U.S. Application Data
(60) Provisional application No. 62/410,649, filed on Oct. 20, 2016.

(51) Int. Cl. G06Q 10/06; G06Q 30/02; G06Q 50/30

(52) U.S. Cl. CPC G06Q 10/06315; G06Q 50/30; G06Q 30/0202

(57) ABSTRACT

A device, system, and method manages a transportation capacity. The method performed at a capacity server includes receiving transportation information from transportation providers in a region, the transportation information comprising transportation options, each transportation option having a respective supply, the supply corresponding to an available remaining occupancy. The method includes determining a respective demand for each transportation option based on respective requests for the transportation options. The method includes determining a regional transportation capacity based on the supply and the demand, the regional transportation capacity indicating a distribution of an overall load in the region to the transportation options. The method includes determining a respective regional efficiency value for each transportation option based on the regional transportation capacity. The method includes generating an availability menu of the transportation options, each transportation option has a characteristic modified based on the respective regional efficiency value.

### PRIORITY CLAIM/INCORPORATION BY REFERENCE

The present application claims priority to U.S. Provisional Patent Application 62/410,649 filed on Oct. 20, 2016 entitled “System and Methods for Managing Transportation Capacity” naming James Barry and Ron Dunsky as inventors, and hereby incorporates, by reference, the entire subject matter of these applications.

### BACKGROUND INFORMATION

A passenger may have a variety of different of ways of scheduling a travel plan in which the passenger travels from a first location to a second location. For example, the passenger may utilize one of a plurality of different modes of transportation within a transportation infrastructure (e.g., air, heavy rail, light rail, ferries, roadways, etc.). In another example, within a given mode of transportation, the passenger may utilize one of a plurality of transportation providers (e.g., available airlines servicing flights from the first location to the second location). In a further example, the passenger may utilize one of a plurality of transportation hubs in which the modes of transportation are available and/or where the transportation providers operate their service (e.g., an airport, a train station, etc.).

From the perspective of the passenger, various parameters may be used to search for transportation options for the travel plan. For example, the passenger may decide on a travel date, a travel time, a travel mode, etc. The passenger may utilize any mechanism to search for the travel options. For example, a transportation provider (e.g., airline, railroad, etc.) may provide an online service in which the passenger may enter the parameters and the search results may be provided to the passenger. The passenger may select and purchase a desired one of the transportation options to complete and reserve this aspect of a travel itinerary. Those skilled in the art will understand that fare price and/or match percentage of the requested parameters may be prioritized in selecting the desired transportation option for the travel plan.

From the perspective of the transportation provider, an indicated transportation option for passengers may be scheduled and may be completed (e.g., if a predetermined minimum amount of occupancy is met). However, the transportation provider often has selfish objectives such as maximizing earned revenue from a scheduled transportation option by maximizing occupancy on the transportation option (e.g., an airline prefers a full flight). Accordingly, the transportation provider may utilize an internal analysis without consideration of consequences associated with efforts in fulfilling this objective. For example, adverse external events may result from this manner of providing a transportation option (e.g., a gridlock event, overbooking, carbon impact, etc.). As the transportation provider aims for the highest occupancy for the transportation option, the transportation provider does not consider referring a requesting passenger to any other transportation option that may be available to the passenger for the intended travel plan. Furthermore, to deter the requesting passenger from using a different transportation provider, the transportation provider may offer a transportation option at a decreased fare.

The manner in which transportation providers attempt to maximize occupancy of its own transportation options and the manner in which passengers may select a desired transportation option based on cost and requested parameters may bias a particular transportation option over other available transportation options. Accordingly, transportation capacity for a travel plan for all passengers (e.g., in a region) may not be evenly distributed. This uneven distribution of passengers in the available transportation options may create adverse results (e.g., increased congestion within a transportation hub, increased congestion on paths to the transportation hub, increased carbon impact, etc.).

### SUMMARY

The exemplary embodiments are directed to a method, comprising: at a capacity server: receiving transportation information from a plurality of transportation providers in a region, the transportation information comprising transportation options, each transportation option having a respective supply, the supply corresponding to an available remaining occupancy; determining a respective demand for each of the transportation options based on respective requests for the transportation options; determining a regional transportation capacity based on the supply and the demand, the regional transportation capacity being indicative of a distribution of an overall load in the region to the transportation options; determining a respective regional efficiency value for each of the transportation options based on the regional transportation capacity; and generating an availability menu of the transportation options, each of the transportation options has a characteristic modified based on the respective regional efficiency value.

The exemplary embodiments are directed to a capacity server, comprising: a transceiver configured to receive transportation information from a plurality of transportation providers in a region, the transportation information comprising transportation options, each transportation option having a respective supply, the supply corresponding to an available remaining occupancy; and a processor determining a respective demand for each of the transportation options based on respective requests for the transportation options, the processor determining a regional transportation capacity based on the supply and the demand, the regional transportation capacity being indicative of a distribution of an overall load in the region to the transportation options, the processor determining a respective regional efficiency value for each of the transportation options based on the regional transportation capacity, the processor generating an availability menu of the transportation options, each of the transportation options has a characteristic modified based on the respective regional efficiency value.

The exemplary embodiments are directed to a method, comprising: at a capacity server: receiving transportation information from a plurality of transportation providers in a region, the transportation information comprising transportation options, each transportation option having a respective supply, the supply corresponding to an available remaining occupancy; determining a respective demand for each of the transportation options based on respective requests for the transportation options; determining a regional transportation capacity based on the supply and the demand, the regional transportation capacity being indicative of a distribution of an overall load in the region to the transportation options; determining a respective regional efficiency value for each of the transportation options based on the regional transportation capacity, the regional efficiency value being a price multiplier, the regional efficiency value being one of a first value between 0 and 1, a unit value, or a second value greater than 1; when the regional transportation capacity is affected by a select one of the transportation options under a predetermined threshold, modifying a price of the selected transportation option with the first value; when the regional transportation capacity is affected by the selected transportation option over the predetermined threshold, modifying the price of the selected transportation option with the second value; and when the regional transportation capacity is affected by the selected transportation option at the predetermined threshold, modifying the price of the selected transportation option with the unit value.

### BRIEF DESCRIPTION OF THE DRAWINGS

FIG. 1 shows an exemplary system for managing a transportation capacity according to the exemplary embodiments.

FIG. 2 shows an exemplary capacity server of the system of FIG. 1 according to the exemplary embodiments.

FIG. 3 shows an exemplary method of managing a transportation capacity according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a device, system, and method for managing a transportation capacity in a region. Specifically, the exemplary embodiments may provide a mechanism in which transportation options available in an origin location of a region and/or transportation options reaching a destination location of a region are managed. As will be described in further detail below, the mechanism according to the exemplary embodiments balance a load across the transportation options of the region to optimize use of a transportation infrastructure on which the transportation options are provided. In balancing the load, the exemplary embodiments further minimize excess capacity associated with a given one or more of the transportation options. The exemplary embodiments additionally provide transportation options to a passenger leading to the load being balanced.

Initially, it is noted that the exemplary embodiments are described with regard to balancing a load of a region and managing a transportation capacity of the region. However, the transportation capacity of a region is only exemplary. The exemplary embodiments may be implemented and/or modified to be used to manage available transportation options for any scenario where balancing a load across the transportation options provides improved performance, improved efficiency, or any improved result.

It is also noted that the exemplary embodiments are described with regard to transportation options associated with passenger travel. However, the use of passenger travel is only exemplary. The exemplary embodiments may be implemented and/or modified to be used with other types of non-passenger transportation needs. For example, the transportation options may also be directed toward merchandise, commerce, livestock, etc.

It is further noted that the exemplary embodiments are described herein based on a prearranged agreement between a plurality of transportation providers. As will be described in further detail below, independent transportation providers may enter into agreements such that an incentive is provided to a first transportation provider that refers a prospective passenger to a transportation option offered by a second transportation provider. For illustrative purposes, the agreement may be assumed to exist among the transportation providers for the features of the exemplary embodiments to be provided. However, the exemplary embodiments may also be configured to form an agreement between transportation providers during a time that a transportation option is being selected by a passenger. That is, the exemplary embodiments do not require that a pre-existing agreement be established between transportation providers. Instead, the exemplary embodiments may utilize an ad hoc agreement for a given passenger such that transportation options provided to this passenger incorporate the features of the exemplary embodiments in balancing a load of a transportation capacity in a region.

The exemplary embodiments provide a mechanism to manage a transportation capacity through balancing a load on available transportation options in a region. Specifically, the exemplary embodiments provide tools for optimizing the use of transportation modes in a transportation infrastructure (e.g., air, heavy rail, light rail, ferries, roadways, etc.), for minimizing excess capacity, for providing real-time travel options for a consumer based on personal consumer preferences and/or infrastructure owner preferences.

According to a first feature of the exemplary embodiments, the exemplary embodiments provide for a real-time information exchange between transportation providers in a region. The information may encompass demand, supply, capacity based on the demand and supply, current conditions (e.g., delay), and projected conditions (e.g., projected delay) for the available transportation modes in the region. Through this information exchange, the exemplary embodiments allow for an increased overall efficiency in a regional transportation network by using all available transportation options to their maximum extent. Specifically, a passenger may be provided a set of transportation options for a travel plan based on available travel information received from transportation providers such that the passenger may select one of these transportation options based on preference (e.g., shortest time including anticipated and projected delays, shortest distance, fewest transfers, lowest carbon impact, lowest price, etc.). The set of transportation options offered to the passenger may encompass risk by providing a range of possible travel times that considers the variability of the circumstances (e.g., the nature of the delay such as traffic jam, car accident, snow storm, etc.).

According to a second feature of the exemplary embodiments, the passenger may be provided enhanced transportation options that encompass non-transportation alternatives. Specifically, the exemplary embodiments may be configured to allow for the consideration of the purpose for travel (e.g., business meeting, vacation, shopping, etc.) and the generation of the transportation as well as non-transportation options may incorporate this consideration. For example, if the purpose for travel is a business meeting, then an additional consideration is whether the meeting must be face to face. The exemplary embodiments may suggest transportation options based on travel considerations (e.g., demand, capacity, price, etc.), time considerations (e.g., maximum time available, flexibility for delay, etc.), and further variables (e.g., weather, available resources other than travel, etc.). Thus, the exemplary embodiments allow a passenger to choose a transportation option based on the relative importance of the various considerations.

According to a third feature of the exemplary embodiments, a dynamic pricing functionality may be used to incentivize maximum use of a transportation capacity. Using the above noted information exchange as well as a cooperation (e.g., a prearranged agreement) between transportation providers (e.g. airlines, airports, governments, roadway transportation services, etc.), the exemplary embodiments provide a mechanism to enhance allocation of transportation resources. The individual transportation providers are not usually incentivized to serve the interests of other transportation providers by spreading its own demand to others with available capacity. However, in balancing the transportation capacity across available transportation modes and transportation options, the exemplary embodiments provide for the consideration of compensation (e.g., subsidies for transportation providers with minimal or overloaded capacity for directing business to other participating transportation providers). In this manner, the transportation providers in a region may be considered a transportation network or a single entity where participating transportation providers may agree on a dynamic pricing scheme that incentivizes efficient use of transportation resources (e.g., minimizing delays, under-loaded transportation infrastructure, carbon impact, various cost considerations, etc.) while compensating for the reduced demand for services of a particular transportation provider. For example, an overburdened airline at a first location may not serve a second location, so this airline would have no incentive to alleviate demand by driving passengers to the second location. A subsidy in the form of compensation for driving demand away would correct this market inefficiency. A pricing algorithm may be used to raise or lower prices of transportation options of participating transportation providers. For example, a passenger may be provided with a first transportation option (e.g., a flight) but associated with congestion, a potential delay (e.g., including estimated delay time), an increased price, etc. and a second transportation option (e.g., a railway) but associated with no congestion, reduced price, comparable travel time as the first transportation option, etc.

In a further aspect of the third feature, as noted above in the second feature, non-transportation options may also be explored and provided to the passenger. Accordingly, the exemplary embodiments may be configured to provide alternatives to travel in the pricing mechanism. For example, a passenger may opt for a video conference instead of traveling (e.g., flying) to a face to face meeting. To incentivize airline participation in the features of the exemplary embodiments, the host of the video conferencing service may offer a credit toward the passenger's next flight.

According to a fourth feature of the exemplary embodiments, the dynamic pricing functionality may be based on a regional efficiency value. This regional efficiency value may refer to an increase or decrease in the price of a given transportation option, expressed as a difference between a current modified price and a standard or assigned price, which reflects the regional interest in using all available regional transportation options in the transportation capacity. Accordingly, the regional efficiency value may be expressed as a price multiplier (e.g., as a value greater than one for increases, as a fraction less than one but greater than zero for decreases). For example, as demand increases and available supply of a first transportation option decreases, it may be preferable to raise the price of the first transportation option, while lowering the price of at least one second transportation option that has lower demand and greater available supply. The increased price of the first transportation option and the decreased price of the second transportation option may be expressed as a regional efficiency value as compared to the standard/assigned price, the difference in price reflecting the value of spreading the demand across the transportation options in the region. Alternatively, the exemplary embodiments may express the dynamic pricing functionality in the form of a bid system, wherein a transportation provider makes a bid to potential passengers (e.g., sets a price for a transportation option), that reflects the type of passenger being sought to accommodate on its available supply.

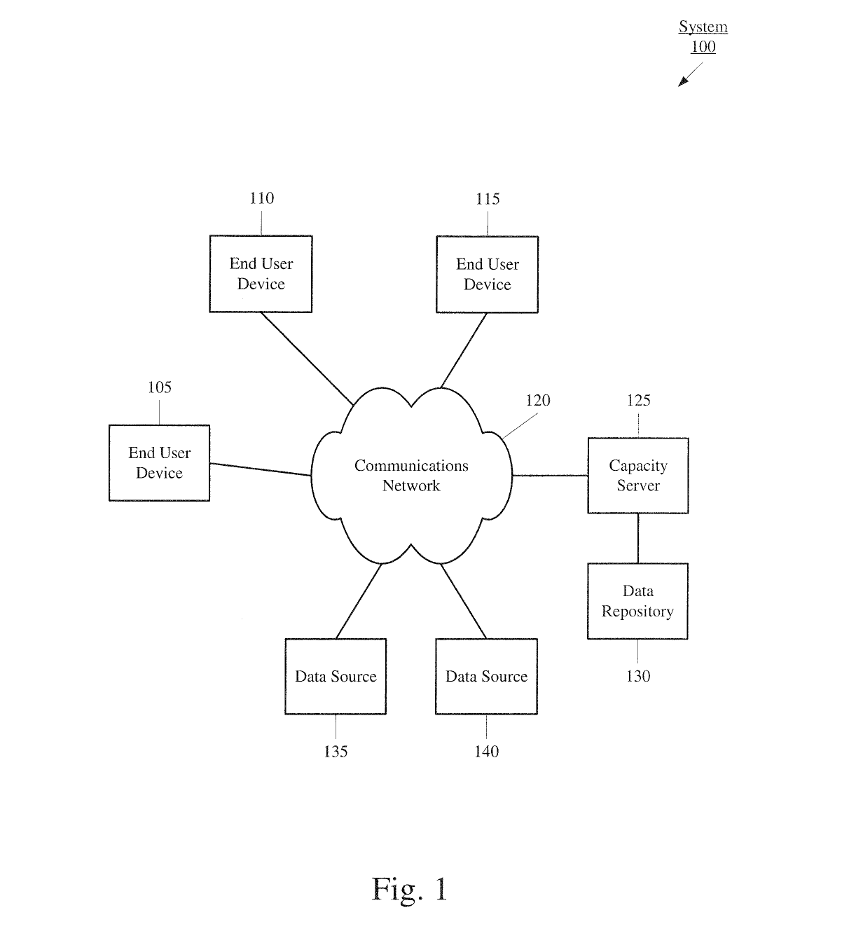

FIG. 1 shows an exemplary system 100 for managing a transportation capacity according to the exemplary embodiments. The system 100 relates to a communication between various components involved in managing a transportation capacity in a region. In providing these features according to the exemplary embodiments, the system 100 may include a plurality of end user devices 105-115, a communications network 120, a capacity server 125, a data repository 130, and a plurality of data sources 135-140.

The end user devices 105-115 may be any electronic device associated with respective users utilizing the features of the exemplary embodiments. Specifically, the end user devices 105-115 may be used by the respective users in updating the information repository and to view the user interface. Accordingly, the end user devices 110-115 may include the necessary hardware, software, and/or firmware to provide any display associated with the features of the exemplary embodiments. For example, the end user devices 110-115 may be stationary devices (e.g., a desktop terminal) or mobile devices (e.g., a smartphone, a tablet, a laptop, etc.). The users may represent any individual or organization who book travel for themselves or for one or more passengers.

The communications network 120 may be configured to communicatively connect the various components of the system 100 to exchange data. The communications network 120 may represent any single or plurality of networks used by the components of the system 100 to communicate with one another. For example, if the end user device 105 is used at an airport, the communications network 120 may include a private network with which the end user device 120 may initially connect (e.g. an airport network). The private network may connect to a network of an Internet Service Provider (ISP) to connect to the Internet. Subsequently, through the Internet, a connection may be established to other electronic devices. For example, the capacity server 125 may be remote relative to the airport but may be connected to the Internet. Thus, the end user device 105 may be communicatively connected to the capacity server 125. In another example, if the end user device 110 is used at a residence, the communications network 120 may include a network of an ISP to connect to the network. It should be noted that the communications network 120 and all networks that may be included therein may be any type of network. For example, the communications network 120 may be a local area network (LAN), a wide area network (WAN), a virtual LAN (ULAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc.

It is noted that the exemplary embodiments are described with regard to the end user devices 110-115 utilizing the features of the exemplary embodiments provided by the capacity server 125 using a connection via the communications network 120. For example, the exemplary embodiments may be implemented as a web service on a webpage hosted by the capacity server 125. In another example, the exemplary embodiments may be implemented as an application executed on the end user devices 105-115 but may rely on a data exchange with the capacity server 125. However, this manner of providing the features is only exemplary and other manners may also be implemented.

The capacity server 125 may be configured to address issued associated with a transportation option that is over-subscribed. Specifically, when a transportation option becomes over-subscribed, a corresponding transportation hub in the region may also become over-subscribed which may lead to further issues arising. By incorporating various factors including the purpose of travel for the passenger, the capacity server 125 may be configured with a set of rules that incorporates all the different capacities (including both supply and demand) for transportation options, transportation modes, transportation hubs, and regional transportation capacities in determining how transportation options that conceivably satisfy a requested travel plan of the passenger is to be presented, particularly with modified pricing (from an assigned pricing). The capacity server 125 considers a shifting, dynamic effect of the plurality of decisions (e.g., thousands or millions of decisions) that are being made that affect these transportation options, modes, hubs, and/or capacities to incentivize the optimal use of a regional transportation capacity by both the passenger and the transportation providers at any given moment.

In a particular example, the region may be a congested major metropolitan area (e.g., New York City). Even with multiple transportation hubs (e.g., LaGuardia Airport, John F. Kennedy International Airport, Newark Liberty International Airport, Penn Station, Grand Central Station, Port Authority Bus Terminal, etc.) that are available for different transportation modes, the region may benefit internally within itself when the transportation modes are balanced. The region may further benefit when outlying areas of the region (e.g., Stewart International Airport, Westchester County Airport, Teterboro Airport, etc.) assist in balancing the transportation capacity. Accordingly, the capacity server 125 may be configured to utilize the set of rules to determine how the loading within the transportation capacity for a region may be distributed.

The data repository 130 may be any component that enables the capacity server 125 to store data used in managing a regional transportation capacity. As those skilled in the art will understand, the capacity server 125 may utilize a relatively large amount of data in dynamically exchanging relevant information used in managing the regional transportation capacity. Accordingly, the capacity server 125 may store data in the data repository 130 as the data is being requested from the data sources 135-140 which are being updated through automatic determinations and manual entries. The data repository 130 may also be used to store data that is not immediately being used by the capacity server 125 in managing the regional transportation capacity. For example, the capacity server 125 may manage data being stored in the data repository from the data sources 135-140 as a sliding window so that data that may be used in managing the regional transportation capacity for a period of time may be readily available.

The data sources 135-140 may represent any source of information that the capacity server 125 may use in managing regional transportation capacities. Initially, it is noted that the data sources 135-140 being represented as two separate sources is only exemplary. The system 100 may include any number of sources from which the capacity server 125 may receive information. With regard to providing assigned or modified pricing for transportation options to a requesting passenger, the data sources 135-140 may include transportation demand and supply information from transportation providers. For example, a transportation provider may provide an interface or outlet in which a passenger may request a selection of transportation options provided by the transportation provider. The requests from the plurality of passengers utilizing the interface of the transportation provider may indicate a demand corresponding to the parameters of the request. In another example, the transportation provider may be privy to an amount of supply available for all transportation options of the transportation provider. The above types of information may be associated with each transportation provider, transportation hub, etc. and included in the data sources 135-140. It is noted that since this information may be proprietary or confidential, the prearranged agreement may provide access to this information at least to the capacity server 125. However, the prearranged agreement may or may not allow access to information of a first transportation provider to a second transportation provider.

The capacity server 125 may also be configured to utilize other information that may affect the regional transportation capacity and management thereof in distributing a load to the transportation options. For example, at least one of the data sources 135-140 may represent any source from which historical information may be received. The historical information may provide previously experienced capacity information that may provide at least a partial basis in managing the transportation capacity. In a first example of historical information, at least one of the data sources 135-140 may store time stamps associated with aircraft ETAs to various positions. In a second example of historical information, at least one of the data sources 135-140 may store map information (e.g., a layout of an airport, a layout of runways at the airport, etc.). In a third example of historical information, at least one of the data sources 135-140 may store historical weather information. Further examples of historical information stored on at least one of the data sources 135-140 may include traffic patterns on roads (e.g., for roadway transportation options such as buses or taxis), construction delays and other types of delays (e.g., for transportation hubs, roadways, etc.), schedules of transportation options, congestion patterns caused by vehicles and/or people, etc.

In another example of information in the data sources 135-140, at least one of the data sources 135-140 may represent any source upon which live performance information may be received. It is noted that live performance information may relate to aircrafts or may also relate to current or predicted conditions. In a first example of the live performance information, at least one of the data sources 135-140 may store real-time information from passive and active radar systems as well as airport and airline information. In a second example of the live performance information, at least one of the data sources 135-140 may store weather forecasts. In a third example of the live performance information, at least one of the data sources 135-140 may store current runway conditions (e.g., construction areas, runway closings, etc.). Other examples of live performance information stored on at least one of the data sources 1350-140 may include current traffic on roads, current construction projects, other delays, current congestion, current schedules, etc.

In a particular implementation of the data sources 135-140, one of the data sources 135-140 may provide a data feed from a passive radar system and/or an active radar system. An exemplary passive radar system may be, for example, the PASSUR System sold by PASSUR Aerospace, Inc. of Stamford, Connecticut. An exemplary active radar system may be, for example, an FAA feed. The information provided by the active and/or passive radar systems may include target data points or positions for a particular aircraft. These target data points may include, for example, the time (e.g., UNIX time), the x-position, the y-position, altitude, x-velocity component, y-velocity component, z-velocity component, the speed, the flight number, the airline, the aircraft type, the tail number, etc.

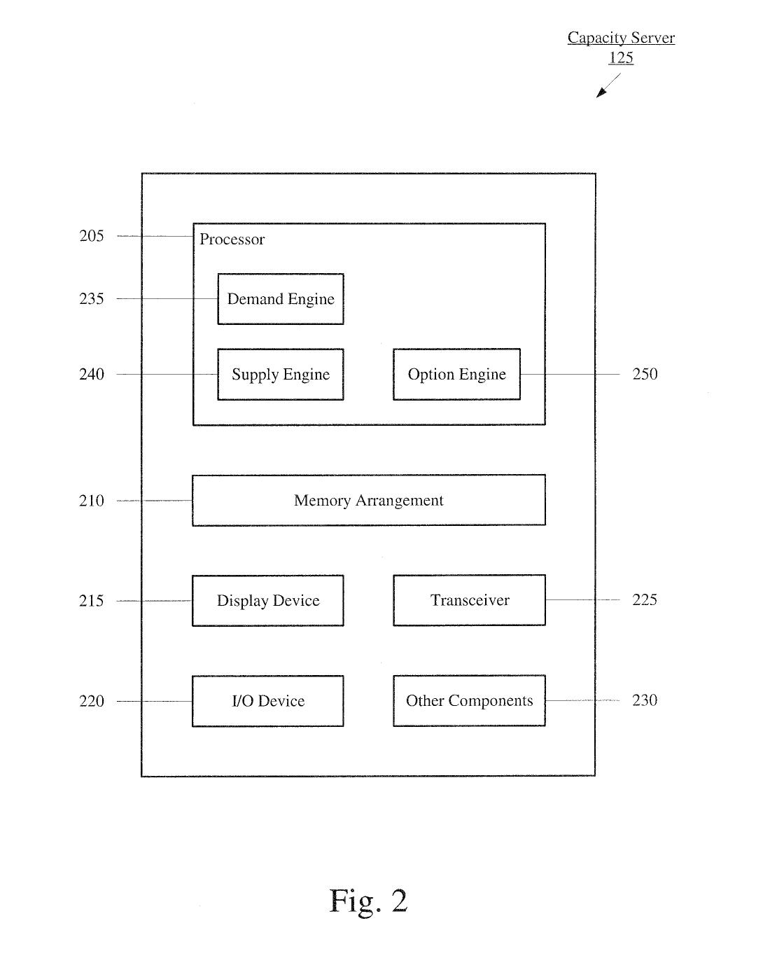

As noted above, the capacity server 125 may utilize the information from the data sources 135-140 to manage a regional transportation capacity. FIG. 2 shows the capacity server 125 of the system 100 according to the exemplary embodiments. Although the capacity server 125 is described as a network component (specifically a server), the capacity server 125 may be embodied in a variety of hardware components such as a portable device (e.g., a tablet, a smartphone, a laptop, etc.), a stationary device (e.g., a desktop terminal), incorporated into the end user devices 105-115, incorporated into a website service, incorporated as a cloud device, etc. The capacity server 125 may include a processor 205, a memory arrangement 210, a display device 215, an input and output (I/O) device 220, a transceiver 225, and other components 230 (e.g., an imager, an audio I/O device, a battery, a data acquisition device, ports to electrically connect the workflow server 150 to other electronic devices, etc.).

The processor 205 may be configured to execute a plurality of applications of the capacity server 125. The processor 205 may utilize a plurality of engines including a demand engine 235, a supply engine 240, an availability engine 245, and an option engine 250. As will be described in further detail below, the demand engine 235 may be configured to receive information associated with demand and determine a first component of the regional transportation capacity. Specifically, the demand engine 235 may determine an expected demand corresponding to a travel request from a passenger for available transportation options matching the request at the origin, the destination, or both. The supply engine 240 may be configured to receive information associated with supply and determine a second component of the regional transportation capacity. Specifically, the supply engine may determine the supply for a travel request from a passenger across the available transportation modes in the available transportation hubs of a region. The option engine 245 may be configured to determine the regional transportation capacity and the regional efficiency value to determine how a transportation option is to be presented to the passenger, particularly by indicating a corresponding assigned or modified price.

It should be noted that the above noted engines each being an application (e.g., a program) executed by the processor 205 is only exemplary. The functionality associated with the engines 235-245 may also be represented as components of one or more multifunctional programs, a separate incorporated component of the capacity server 125 or may be a modular component coupled to the capacity server 125, e.g., an integrated circuit with or without firmware.

The memory 210 may be a hardware component configured to store data related to operations performed by the capacity server 125. The display device 215 may be a hardware component configured to show data to a user while the I/O device 220 may be a hardware component that enables the user to enter inputs. For example, an administrator of the capacity server 125 may maintain and update the functionalities of the capacity server 125 through user interfaces shown on the display device 215 with inputs entered with the I/O device 220. It should be noted that the display device 215 and the I/O device 220 may be separate components or integrated together such as a touchscreen. The transceiver 225 may be a hardware component configured to transmit and/or receive data via the communications network 120.

According to the exemplary embodiments, the capacity server 125 may be configured to capture dynamically changing demand and supply that reflects a real-time impact of individual choices being made for a regional transportation capacity. By further incorporating conditions and other information that may affect the regional transportation capacity, the capacity server 125 may determine a manner in which to distribute a load on the regional transportation capacity across available transportation options for a travel request of a passenger. In this manner, the capacity server 125 may provide a set of transportation options that reflect the shifts in the regional transportation capacity from which the passenger may make a selection depending on personal considerations (e.g., what is most important to the passenger).

In providing these features, the capacity server 125 may provide social goods. For example, the capacity server 125 may provide an improvement to an overall efficiency in the regional transportation capacity and the system of the region providing transportation to passengers. Specifically, the capacity server 125 may balance a load of the regional transportation capacity to utilize all available transportation options to its maximum extent. In this manner, the capacity server 125 may reduce delays, wasted productivity, carbon emissions, etc. When in use, the capacity server 125 may balance the load of the regional transportation capacity by distributing demand for transportation in or out of a given region on all the different transportation options in a manner that use of the regional transportation capacity is maximized and potential waste is minimized. In an exemplary implementation, the capacity server 125 may be used to spread the load across the transportation options and avoid overburdening use of a first transportation option when at least one second transportation option is available.

As described herein, the capacity server 125 may be utilized for transportation options selected by passengers. For example, as a preferred selected transportation option or transportation route (e.g., from a particular origin to a particular destination on a specific transportation mode) becomes congested, the capacity server 125 may offer an alternative transportation option/route to the passenger with an incentive (e.g., a less congested transportation route at a lower price). However, as noted above, the capacity server 125 may also provide transportation options to other entities including airlines, airports, etc. Specifically, the capacity server 125 may also balance a load of a regional transportation capacity using resolutions unrelated to a transportation option for a passenger. For example, the capacity server 125 may receive information for oversubscribed (e.g., increased usage) and/or undersubscribed (e.g., decreased usage) runway/fix combinations for departures. The capacity server 125 may arrange for an airline to change a departure route to take advantage of an available, less congested departure route (e.g., of a supply of departure routes). This arrangement may be based on an exchange such as using a less congested path (and less overall transit time) but at the cost of additional fuel burn. Accordingly, the exemplary embodiments may also provide transportation options for transit to various entities associated with the regional transportation capacity.

In one aspect of managing the regional transportation capacity, the capacity server 125 may utilize an information exchange with regard to regional demand and regional supply at the origin and destination of an intended travel of a passenger. For illustrative purposes, the description herein relates to the origin of the intended travel. Thus, the regional demand may relate to the demand at the transportation hubs (e.g., airport, station, depot, terminal, pier, etc.) of the transportation modes (e.g., air, rail, car, bus, ferries, etc.). As noted above, the demand engine 235 may receive demand information to determine an expected demand while the supply engine 240 may receive supply information to determine the supply for a travel request.

Utilizing the outputs of the demand engine 235 and the supply engine 240, the option engine 245 may determine how to balance the regional transportation capacity. Specifically, based on the factors affecting the regional transportation capacity, the output engine 245 may utilize a set of rules in determining a corresponding regional efficiency value. The regional efficiency value may be indicative of whether a particular transportation option is to have increased or decreased appeal for selection to a passenger. For example, the regional efficiency value may be a multiplier to an assigned price to the transportation option. Accordingly, using the regional efficiency value, a dynamic pricing scheme may be used to set a price for a transportation option. For example, an initial price may be an assigned price when no weight is given to use of the transportation option (e.g., a price set by the transportation provider) such that the regional efficiency value is a unit value. Otherwise, the price may be a modified price that uses a fractional regional efficiency value that is greater than zero but less than unity when increased weight is given to use of the transportation option (e.g., to generate a decreased price to entice selection) or a regional efficiency value greater than unity when decreased weight is given to use of the transportation option (e.g., to generate an increased price to deter selection). As noted above, a set of rules utilized by the capacity server 125 may define the manner in which the regional efficiency value is determined based on inputs including the demand and supply of the transportation hub identified in the transportation option.

A mechanism that may encapsulate the demand, supply, passenger preferences, etc. may be price. Specifically, the use of an assigned price or a modified price (using the regional efficiency value) may drive the balancing of the load of the regional transportation capacity by attracting attention and selections to a directed, uncongested transportation option while deterring selections to an overloaded transportation option. The price may also introduce a concept of incentives or subsidies. For example, the dynamic pricing functionality according to the exemplary embodiments may consider an objective to use all available transportation options to their respective fullest, especially to offset growing concentrations of demand on a first transportation option that may result in delays. As such, the dynamic pricing functionality may dynamically lower the price of a transportation option (e.g., a plane ticket) to a destination from a first origin in a region (e.g., Hartford) relative to a second origin (e.g., LaGuardia). In fact, the price may be increased for the second origin. Accordingly, the regional efficiency value for the first origin may be less than unity while the regional efficiency value for the second origin may be greater than unity. When a further transportation mode is also considered and provided in a set of transportation options, the dynamic pricing functionality may offer an even more lowered price on a second transportation option (e.g., train). Accordingly, the regional efficiency value for the further transportation mode may apply a regional efficiency value less than unity that may be lower than the regional efficiency value of the first origin. In fact, if the first origin and the further transportation mode were available for a transportation option, the regional efficiency value may incorporate these factors to generate an even greater lowered price. Each transportation option involves different trade-offs for different passengers (e.g., time, convenience, etc.) but pricing may be the mechanism that incentivizes a review of all the transportation options being provided to a passenger.

In addition to the outputs of the demand engine 235 and the supply engine 240, the option engine 245 may also receive other pertinent information that may affect the regional transportation capacity. For example, the option engine 245 may exchange information relating to current and/or projected delay on each of the transportation options. The supply and demand of each of the transportation options may directly affect the regional transportation capacity. However, the delay information may also impact the regional transportation capacity through a constructive increase in demand and/or a constructive decrease in supply to a transportation option. Specifically, the constructive increase in demand or the constructive decrease in supply may relate the consequences of demand or supply. For example, the delay may constructively increase the demand as the transportation option may increase a time necessary for the transportation option to be completed (e.g., to service, to unload passengers/cargo, to load following passengers/cargo, etc.). This delay may create increased overlap in time with other transportation options at a transportation hub. A substantially similar effect may be experienced with an increase in demand. Accordingly, other information may also be utilized by the option engine 245 to be used alone or in conjunction with the demand and supply information. Specifically, the regional efficiency value may be modified to incorporate this other information. In fact, the other information may constructively or destructively interfere with the demand/supply to affect the regional efficiency value.

The capacity server 125 may additionally receive parameters or preferences from the passenger that affects the manner in which transportation options are presented for selection. For example, the passenger may indicate which parameter for a travel option has a greatest importance in selection (e.g., shortest time including anticipated/projected delays, shortest distance, lowest carbon impact, lowest price, etc.). The capacity server 125 may arrange the transportation options according to a preferred list order and present the transportation options to the passenger.

The parameters/preferences may also include additional information that is used by the capacity server 125 to provide further transportation options that may not entirely match the parameters entered for a desired travel but may provide benefits to the passenger that were not entirely considered. For example, the passenger may indicate a reason for travel such as a business meeting or to give a presentation including the details of when this reason at the destination is to occur. If the capacity server 125 has identified a transportation option that enables the passenger to arrive at the destination at an earlier than requested time (e.g., to prepare for the meeting to have extra time for unexpected events such as delays, traffic, weather, etc.) but which also balances a load of the regional transportation capacity, the capacity server 125 may provide this transportation option with a modified pricing to entice the passenger in selecting this option over other options that has an increased match to the requested parameters of the desired travel.

The above describes the features of the exemplary embodiments based on the individual operations that are performed and the factors that are considered in balancing a load of a regional transportation capacity. When considering the features of the exemplary embodiments from another perspective, the capacity server 125 may be viewed as a transportation market mechanism. For example, the capacity server 125 may balance the load of the regional transportation capacity but may also balance any unfair market shifts that may be created. Although the passenger may be provided a seamless experience in which transportation options are provided with corresponding pricing, the capacity server 125 may also balance the market such that transportation providers are given their due share of the market, particularly when referring a passenger to another available transportation option that balances the load of the regional transportation capacity.

In terms of buyers and sellers in a market environment, the passenger may be the buyer and the transportation providers may be the sellers. More specifically, a group comprising the transportation providers in a region may represent a seller entity. However, for purposes of the market description that utilizes the features of the exemplary embodiments, the seller entity may be considered a single unit. However, it is noted that the seller entity is indeed made up of multiple transportation providers (e.g., airlines, airports, governments, etc.).

In this market analogy, the capacity server 125 may compensate for the inefficiency of the transportation market where each of the different transportation providers are only driven by selfish interests of having passengers use their specific travel option in isolation of other travel options, particularly of other transportation providers. Accordingly, the capacity server 125 overcomes situations that are created where one or more of the transportation options (e.g., a transportation mode such as road or air) is hugely oversubscribed while others (e.g., rail) may be largely undersubscribed or where a transportation hub (e.g., an airport such as LaGuardia Airport) is hugely oversubscribed while another nearby transportation hub (e.g., Stewart Airport) is largely undersubscribed.

By treating the transportation providers as a single unit, the capacity server 125 more rationally spreads the load of the regional transportation capacity, particularly the demand by letting buyers weigh different transportation options depending on personal priorities. However, with the seller and the assets (e.g., the transportation options) being associated with a single unit, the capacity server 125 may also consider subsidies that may be agreed upon by the transportation providers in a prearranged agreement. For example, it may not be in a given transportation provider's interest to drive buyers away from a first transportation hub to a second transportation hub, particularly if the transportation provider does not serve the second transportation hub. The transportation provider may not care that demand at the first transportation hub is creating delays that may be alleviated if some of the passengers select transportation options at the second transportation hub since all demand at the second transportation hub is lost revenue for the transportation provider. Thus, for the transportation provider to be incentivized to participate in a regionally rationalized spread-load of travel demand in an overall regional transportation capacity, the transportation provider may be compensated in some manner for reduced demand out of the first transportation hub.

In a particular implementation, when a passenger is viewing transportation options provided by the transportation provider, the transportation provider may receive further transportation options of other transportation providers, transportation hubs, transportation modes, etc. The transportation provider may present these transportation options to the passenger. The presentation of the options alone may include subsidies. When a passenger proceeds to select one of these further transportation options, the transportation provider may be compensated in the form of a subsidy. Even if the passenger utilizes a general search mechanism that peruses through transportation options of multiple transportation providers, the capacity server 125 may operate in conjunction with the transportation providers and the general search mechanism to provide the transportation options in a way that balances the load of the regional transportation capacity.

The capacity server 125 may not be limited to only balancing the load of the regional transportation capacity by shifting demand and supply to determined transportation options. The capacity server 125 may also balance the load of the regional transportation capacity by removing demand altogether if a non-travel option is available. As noted above, the capacity server 125 may receive inputs from the passenger. For example, the inputs may include a reason for travel. When the reason requires travel (e.g., seeing a relative, visiting a location, etc.), the capacity server 125 may utilize the above features and provide a corresponding set of transportation options. However, when the reason only prefers travel (e.g., a business meeting preferred to be face to face), the capacity server 125 may determine if a non-travel option may be used to accomplish the objective but not necessarily in the preferred manner. For example, the capacity server 125 may provide a non-travel option for a video conference. By using a non-travel option, the passenger may be removed from the demand of the regional transportation capacity. In using this non-travel option, there may be subsidies that are also used, including to the user who is no longer a passenger. For example, a beneficiary of this selection (e.g., an entity that provides the video conferencing service) may offer a credit toward a next flight or hotel stay for the user.

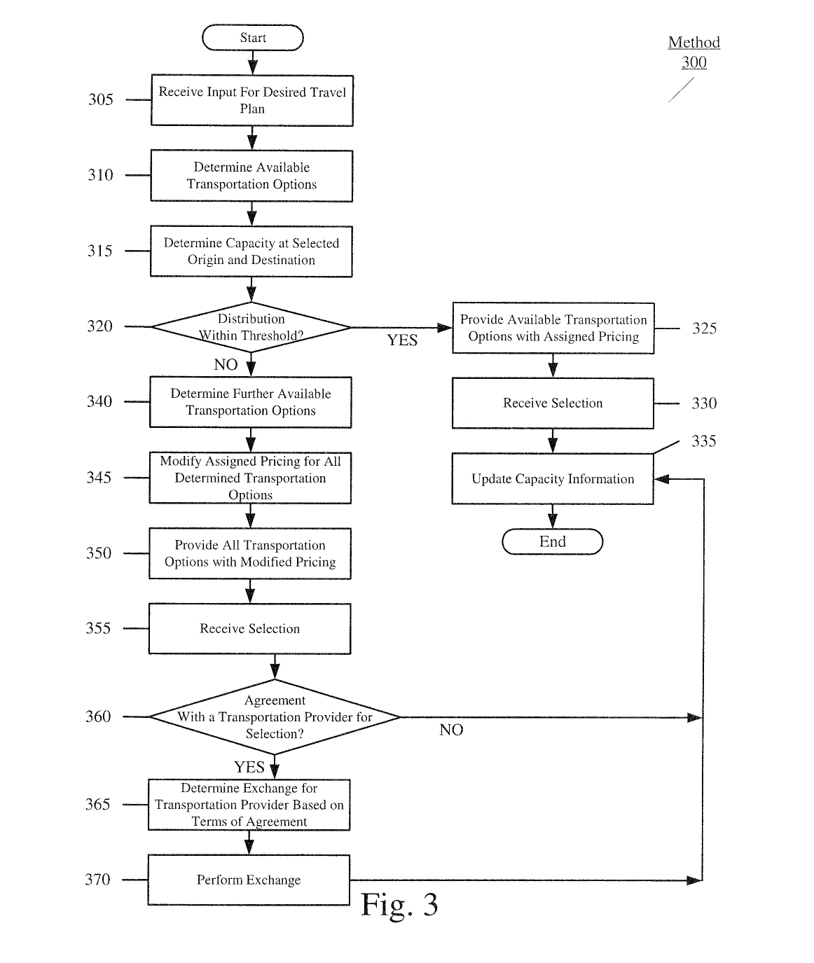

FIG. 3 shows a method 300 of managing a regional transportation capacity according to the exemplary embodiments. Specifically, the method 300 may relate to balancing a load across available transportation options in a region at both an origin and a destination for the transportation options. The method 300 will be described from the perspective of the capacity server 125. The method 300 will also be described with regard to the system 100 of FIG. 1 and the capacity server 125 of FIG. 2.

In 305, the capacity server 125 receives an input from a passenger for a desired travel plan. For example, the input may include an origin, a destination, preferred transportation hubs, preferred transit times, preferred transportation modes, etc. In another example, the input may include other information such as preferences in transportation options, purpose of travel, details of the purpose, etc. The capacity server 125 may receive the input from the passenger directly or indirectly. In a first example, the capacity server 125 may be associated with a service in which passengers are provided transportation options. Accordingly, through a user interface, the passenger may directly provide inputs. In a second example, the capacity server 125 may be associated with transportation providers or general travel search providers. Thus, through respective user interfaces of these entities, a passenger may provide inputs which may then be forwarded to the capacity server 125.

In 310, the capacity server 125 determines or identifies available travel options. Specifically, the travel options that are determined may be those that match at least a predetermined minimum amount of the parameters of the desired travel provided by the passenger. For example, the passenger may have identified a date, an origin transportation hub, a destination transportation hub, and a transportation mode. Based on these inputs, the capacity server 125 may query the transportation providers (e.g., the data sources 135-140) for transportation options that match (or at least match to a degree corresponding to the predetermined minimum amount) these inputs.

In 315, the capacity server 125 determines a capacity at the selected origin and destination, assuming the passenger entered this information. As noted above, the regional transportation capacity may relate to a demand and a supply for each of the transportation options. A combination of these demands and supplies may indicate whether a particular transportation option is over or under-subscribed. Further considerations may also be incorporated. For example, demand and supply of other transportation options at the same transportation hub, using the same transportation mode, expected or predicted delays, forecast weather, etc. may be determined and a consequent effect to the regional transportation capacity may be determined.

In 320, the capacity server 125 determines whether a distribution or load on the regional transportation capacity for the regions of the origin and/or destination is within an acceptable threshold. The acceptable threshold may relate to whether the transportation options and the overall use of these transportation options create an imbalanced load or otherwise adverse result to the regional transportation capacity. If the regional transportation capacity associated with the transportation options are within the acceptable threshold, the capacity server 125 continues to 325. For example, if a sample size is not yet large enough (e.g., demand is low and supply is high), the use of the transportation options may not adversely affect the regional transportation capacity. Thus, in 325, the capacity server 125 may determine that a regional efficiency value may be set to unity. That is, assigned prices of the transportation options may be used without modification. The capacity server 125 may therefore provide the available transportation options with the assigned pricing (e.g., assigned pricing with a unity multiplier). In 330, the capacity server 125 receives a selection from the passenger from the available transportation options. In 335, the capacity server 125 updates the information associated with the regional transportation capacity.

Returning to 320, if the regional transportation capacity associated with the transportation options is outside the acceptable threshold, the capacity server 125 continues to 340. For example, if a sample size is large enough (e.g., demand is high and supply is low for a particular transportation option), further use of the transportation options may adversely affect the regional transportation capacity. Thus, in 340, the capacity server 125 determines further available transportation options. Specifically, the further available transportation options may not match the inputs from the passenger to the predetermined minimum amount. However, the further available transportation options may match the inputs to a further predetermined minimum amount. For example, an origin may be used as a flexible parameter.

In 345, the capacity server 125 modifies the assigned pricing for the transportation options determined in 310 and the further transportation options determined in 340 in a manner that balances the load of the regional transportation capacity. For example, when related to the origin, the capacity server 125 may modify the assigned pricing for those transportation options that include the indicated origin which adversely affects the regional transportation capacity of the region including the origin (e.g., in an unfavorable way). The capacity server 125 may modify the assigned pricing for those transportation options that include a different origin which may alleviate the load of the regional transportation capacity of the region including the origin (e.g., in a favorable way). In this manner, through incorporation of the factors that affect the regional transportation capacity, the capacity server 125 may determine a corresponding regional efficiency value that is to be applied to the assigned pricing. For example, when a transportation option adversely affects the regional transportation capacity, the regional efficiency value may utilize a value greater than unity as a multiplier to increase the assigned price. When a transportation option positively affects the regional transportation capacity, the regional efficiency value may utilize a positive fractional value less than unity as a multiplier to decrease the assigned price. In this manner, the capacity server 125 utilizes a dynamic pricing functionality. In 350, the capacity server 125 may provide the transportation options with the corresponding modified prices.

In 355, the capacity server 125 receives a selection from the transportation options provided in 350. Since a modified price is used for the selection, in 360, the capacity server 125 determines whether an agreement with one or more transportation providers exists for the selection. As noted above, a transportation provider may have entered into a prearranged agreement with another transportation provider. A transportation provider may have also entered into a prearranged agreement to be a party to a spread-loading service for a regional transportation capacity. Accordingly, if the selection involves one or more transportation providers who may be awarded subsidies or compensation, in 365, the capacity server 125 may determine an exchange for the transportation provider based on the terms of the agreement. In 370, the capacity server 125 performs the exchange. Thereafter, the capacity server 125 continues to 335. If no agreement exists for the transportation providers, the capacity server 125 also continues to 335 from 360.

It is noted that the method 300 may include additional operations. For example, there may be an agreement with the passenger. Specifically, if the passenger selects a non-travel option, the passenger may be rewarded as the passenger effectively reduces the demand associated with the parameters of the desired travel plan. Thus, the method 300 may include further operations that determine the exchange for the passenger. In another example, further information and considerations may be utilized in determining whether a load of the regional transportation capacity is within the acceptable threshold as well as in modifying assigned prices. In a further example, the use of 320 where an acceptable threshold is used is only exemplary. The method 300 may be configured to always provide the available transportation options and the further transportation options. The method 300 may also be configured to enable the passenger to select whether the features of the exemplary embodiments are to be used, to always be used, etc. In an additional example, the method 300 may be configured to determine how non-passenger related options may be used in balancing the load of the regional transportation capacity (e.g., using a different route at the cost of fuel burn).

The exemplary embodiments describe a device, system, and method for managing a transportation capacity in a region. The mechanism according to the exemplary embodiments incorporate any factor that may affect a regional transportation capacity and provide transportation options to passengers or other entities such as airlines that compensate for an imbalanced load to the regional transportation capacity, particularly when a transportation option is oversubscribed. Through managing demand, supply, and other factors, the exemplary embodiments manage the load of a regional transportation capacity and balance transportation options such that a distribution enables the transportation options are used to their fullest.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
at a capacity server:
receiving transportation information from a plurality of transportation providers in a region, the transportation information comprising transportation options, each transportation option having a respective supply, the supply corresponding to an available remaining occupancy;
determining a respective demand for each of the transportation options based on respective requests for the transportation options;
determining a regional transportation capacity based on the supply and the demand, the regional transportation capacity being indicative of a distribution of an overall load in the region to the transportation options;
determining a respective regional efficiency value for each of the transportation options based on the regional transportation capacity; and
generating an availability menu of the transportation options, each of the transportation options has a characteristic modified based on the respective regional efficiency value.

2. The method of claim 1, wherein the transportation options are performed according to a transportation schedule.

3. The method of claim 2, wherein each transportation option utilizes a respective transportation mode from an origin transportation hub to a destination transportation hub.

4. The method of claim 1, wherein the characteristic is a price of a select one of the transportation options.

5. The method of claim 4, wherein the regional efficiency value for the selected transportation option is a multiplier to the price of the selected transportation option.

6. The method of claim 5, wherein the regional efficiency value is between 0 and 1 when the regional transportation capacity is affected by a selection of the selected transportation option under a predetermined threshold.

7. The method of claim 6, wherein the regional efficiency value is greater than 1 when the regional transportation capacity is affected by the selection of the selected transportation option above the predetermined threshold.

8. The method of claim 1, wherein the characteristic is a position used or a path taken by the transportation option.

9. The method of claim 1, wherein the regional efficiency value is determined further based on additional factors.

10. The method of claim 9, wherein the additional factors are based on historical information of the transportation options, weather forecasts, expected conditions, predicted delays, or a combination thereof.

11. The method of claim 1, further comprising:
receiving a travel request including information identifying a plurality of parameters, the transportation options matching at least a predetermined minimum of the parameters.

12. The method of claim 11, further comprising:
determining whether the regional transportation capacity is within an acceptable threshold range; and
when the regional transportation capacity is outside the acceptable threshold range, determining further transportation options, the further transportation options matching at least a further predetermined minimum of the parameters, the further predetermined minimum being less than the predetermined minimum.

13. The method of claim 12, further comprising:
determining a respective further regional efficiency value for each of the further transportation options based on the regional transportation capacity.

14. The method of claim 13, wherein the availability menu is generated to further include the further transportation options, each of the further transportation options having a characteristic modified based on the further respective regional efficiency value.

15. A capacity server, comprising:
a transceiver configured to receive transportation information from a plurality of transportation providers in a region, the transportation information comprising transportation options, each transportation option having a respective supply, the supply corresponding to an available remaining occupancy; and
a processor determining a respective demand for each of the transportation options based on respective requests for the transportation options, the processor determining a regional transportation capacity based on the supply and the demand, the regional transportation capacity being indicative of a distribution of an overall load in the region to the transportation options, the processor determining a respective regional efficiency value for each of the transportation options based on the regional transportation capacity, the processor generating an availability menu of the transportation options, each of the transportation options has a characteristic modified based on the respective regional efficiency value.

16. The capacity server of claim 15, wherein the transportation options are performed according to a transportation schedule, and wherein each transportation option utilizes a respective transportation mode from an origin transportation hub to a destination transportation hub.

17. The capacity server of claim 15, wherein the characteristic is a price of a select one of the transportation options, and wherein the regional efficiency value for the selected transportation option is a multiplier to the price of the selected transportation option.

18. The capacity server of claim 17, wherein the regional efficiency value is between 0 and 1 when the regional transportation capacity is affected by a selection of the selected transportation option under a predetermined threshold.

19. The capacity server of claim 18, wherein the regional efficiency value is greater than 1 when the regional transportation capacity is affected by the selection of the selected transportation option above the predetermined threshold.

20. A method, comprising:
at a capacity server:
receiving transportation information from a plurality of transportation providers in a region, the transportation information comprising transportation options, each transportation option having a respective supply, the supply corresponding to an available remaining occupancy;
determining a respective demand for each of the transportation options based on respective requests for the transportation options;
determining a regional transportation capacity based on the supply and the demand, the regional transportation capacity being indicative of a distribution of an overall load in the region to the transportation options;
determining a respective regional efficiency value for each of the transportation options based on the regional transportation capacity, the regional efficiency value being a price multiplier, the regional efficiency value being one of a first value between 0 and 1, a unit value, or a second value greater than 1;
when the regional transportation capacity is affected by a select one of the transportation options under a predetermined threshold, modifying a price of the selected transportation option with the first value;
when the regional transportation capacity is affected by the selected transportation option over the predetermined threshold, modifying the price of the selected transportation option with the second value; and
when the regional transportation capacity is affected by the selected transportation option at the predetermined threshold, modifying the price of the selected transportation option with the unit value.
